(19) United States
(12) Patent Application Publication
(10) Pub. No.: US 2015/0367909 A1
(43) Pub. Date: Dec. 24, 2015

(54) DUAL DRIVE BICYCLE

(71) Applicant: Kenneth Haan, Fort Lauderdale, FL (US)

(72) Inventor: Kenneth Haan, Fort Lauderdale, FL (US)

(21) Appl. No.: 14/744,777

(22) Filed: Jun. 19, 2015

Related U.S. Application Data
(60) Provisional application No. 62/015,393, filed on Jun. 21, 2014.

(51) Int. Cl. B62M 1/12; B62M 9/02; B62K 21/16; B62M 1/36

(52) U.S. Cl. CPC B62M 1/12; B62M 1/36; B62M 9/02; B62K 21/16

(57) ABSTRACT

A dual drive bicycle is provided having a front wheel, hand-cranked drive train including at least two pairs of a drive sprocket and driven sprocket, thereby allowing the diameter of the drive sprocket in the handlebar area to be made much smaller, thereby reducing the exposure of the hands and face of the rider to the sprocket teeth and chains of the front wheel drive train. The multiple pairs of drive sprockets and driven sprockets are mounted on a dual crown front fork that safely allows the use of a wider front hub without introducing unsafe bending stresses into the forks, and greatly facilitates the addition of the front wheel drive train of the invention to any bicycle. The invention also encompasses a steering assembly kit that converts a conventional bicycle to the dual drive bicycle of the invention by adding the front wheel drive train of the invention to a conventional bicycle.

### RELATED APPLICATIONS

This application claims priority from U.S. provisional patent application No. 62/015,393 filed Jun. 21, 2014.

### FIELD OF THE INVENTION

This invention generally relates to dual drive bicycles, and is specifically concerned with a bicycle having a sprocket-based, independent chain or belt driven hand-pedaled front wheel drive transmission system that is powered by rotating a pair of rotatable handlebars.

### BACKGROUND OF THE INVENTION

Dual drive bicycles having a front wheel, hand-cranked drive in combination with a rear wheel, foot-pedaled drive are know in the prior art. In these prior art dual drive bicycles, the front wheel, hand-pedaled drive is typically merely a re-configuration of the same sprocket-and-chain drive components used in conventional rear wheel, foot-pedaled drive. For example, Phillips U.S. Pat. No. 4,773,662 and Liao US Published Application 2010/0059962A1 both use a single sprocket mounted in the handlebar area of the bicycle and a single long chain that engages a smaller sprocket at the front wheel.

### SUMMARY OF THE INVENTION

In such prior art dual drive bicycles, it is necessary for the diameter of the front wheel sprocket to be on a par with the diameter of the rear wheel sprocket in order to obtain a practical gear speed ratio that allows the rider to effectively drive the front wheel of the bicycle with the hand cranks. This in turn requires the use of a relatively large-diametered sprocket which, when rotatably mounted in the handlebar area of the bicycle, is necessarily close to the hands and face of the rider. Such an arrangement is potentially dangerous, exposing the rider to the potential risk of facial cuts on the sprocket or having his or her fingers caught between the front wheel sprocket and chain, particularly in the event of an accident. While the dual drive bicycle disclosed in Phillips U.S. Pat. No. 4,773,662 attempts to mitigate these risks by providing a metal cover over the chain, such a cover adds weight and makes the gears and locking pin inaccessible. The prior art also does not replace the front forks, but instead spreads the front fork to accommodate the wider geared hub needed for the front wheel drive. This puts unsafe stress on the front forks. Finally, the presence of a large-diametered sprocket on the handle bars is unsightly, and tends to ruin the otherwise sleek and streamlined appearance that modern bicycle designs aspire to.

This invention eliminates or at least ameliorates all of the aforementioned shortcomings associated with prior art front wheel, hand-cranked drives by the provision of at least two pairs of drive sprocket and driven sprocket which allows the diameter of the drive sprocket in the handlebar area to be made much smaller, thereby reducing the exposure of the hands and face of the rider to the sprocket teeth and chains of the front wheel drive train. The use of a smaller diameter sprocket in the handlebar area of the bicycle also improves the aesthetic appearance of the dual drive bicycle. Moreover, standard front forks associated with the prior art are preferably replaced with wider-spaced dual crown front forks that safely allows the use of a wider front hub without introducing unsafe bending stresses into the forks. This greatly facilitates the addition of the front wheel drive train of the invention to any bicycle.

The invention also comprises a conversion kit that adds the front wheel drive train of the invention to a conventional bicycle. The conversion kit includes at least two pairs of drive sprocket and driven sprocket for driving the front wheel, and a dual crown front fork that provides robust support for the pairs of drive sprockets and driven sprockets while maintaining easy access to all parts of the drive train.

The invention provides a dual drive bicycle complete with a traditional rear drive and a hand pedaled front wheel drive mounted on a dual crown fork support structure. One can pedal with the feet only, pedal with the hands only or use both at the same time. One can also simply coast and not use either hands or the feet. One can stand up and just use the hands for a shoulder shrug type of work out. Multiple handle positions allow the muscles of the back shoulders and arms to stay relaxed and not cramp on long rides.

Other objects and advantages of the invention are set forth below.

### OBJECTS AND ADVANTAGES

The present invention relates to hand-and-foot pedaled chain or belt driven bicycles wherein a front wheel, hand-pedaled drive is independent of a rear wheel, foot-pedaled drive. Advantageously, the front wheel drive is made safer and more aesthetically pleasing by decreasing the size of the top sprocket. This is accomplished by utilizing a several gear trains in a row to get the required 1:5.5 gear speed ratio, required for a smooth yet exercise-worthy ride. The use of a dual crown front fork as the support frame simplifies the drive system by combining ease of attachment and functionality. The added benefit of maintaining the geometry and flow of the bicycle frame was an added bonus.

The object of this invention is to provide a total aerobic workout while riding a bicycle. The subject invention adds a hand pedaled front wheel drive system to the head tube of any bicycle and accomplishes that mission. Another object of this invention is to make a dual drive bicycle that is acceptable in the marketplace. All past prior art attempts have thus far failed to do so as evidenced by the lack of commercial success. Using a dual crown front fork as the support frame for a chain or belt driven front wheel drive solves the problems of the prior art. The chain driven appendages the prior art added to the front end of their bicycles precluded any chance for commercial success. No attempts were made to reduce the size of the top sprocket. The prior art all used the standard large sprocket to small sprocket set up that is standard at the rear wheel. The large sprocket was dangerously close to your face. Phillips' invention (2001) abandoned due to lack of commercial success, used an unsightly cover for protection and no easy access.

The subject invention uses a very small sprocket up top and covers the chain with a plastic chain guard that rotates with the chain and has individual links just like the chain. The advantage is that this cover looks like a chain, is lightweight and is easily unsnapped for maintenance. One of the failures of Phillips most recent 2001 Patent was access to the chain drive for maintenance. That said, one of the objects and advantage to the present invention is that it is open source chain and gear maintenance. Replacing the standard front fork with a dual crown front fork allows for the wider multispeed hubs to be used. The advantage is that the front fork does not have to be unsafely spread apart to force in a wider hub as Phillips uses for his conversion kit. Phillips and other prior art use the existing front forks and do not replace the front fork and therefore must unsafely spread the forks to accommodate the wider hub. Yet another object of this invention is to utilize and combine existing, off the shelf parts to build the front wheel drive assembly. Chains, dual crown front forks, crank arms, chain cover plastic links, stems, adjustable stem risers, rear wheels, and freewheel cassettes are all readily available. The same apples for belt drives. Another object of this invention is to add LED lighting to light the crank arms for added nighttime visibility. In another embodiment LEDs strips are added to the front forks and rotating chain guard.

Yet another object of this invention is to use the stems as support for the rotatable handle bar assembly. Another advantage of the dual crown front forks as a support frame is that slide able stem mounts are used to attach the multiple sprockets and chains. Any stretching of the chain over time is easily fixed by sliding the stems and adjusting the distance between gears and making the chain taut. The sprockets are easily accessible and individuals can change to their desired gear speed ratio with ease by seething one size sprocket for another. The bike shops can do this for the mechanically challenged. Another advantage of this dual crown set up is that two stem clamps instead one for the handle bar assembly increase the overall strength of front wheel drive. All previous front drive prior art use a single stem tube to attach the handle bar assembly. An object of this invention is to make the front drive as open source as possible. This front wheel drive is wide open and gear changes for the techie type garage bike mechanic are simple and accessible. Another object of this invention is to use smaller sprockets.

The preferred embodiment utilizes a connected system of three chains and gear sets. All other prior art uses Just two. The use of three gear trains allows the individual sprockets to be much smaller in size while still maintaining a 1:5.5 gear speed ratio. This solves the problem of having a huge sprocket in your face. Another object of this invention is to accommodate any size rider's torso. There are several ways to accomplish this with this invention. The stem mounts are manufactured longer and with a higher angled attitude for the taller rider. The second way is to have the fork tubes manufactured longer or shorter according to the rider's torso. In another preferred embodiment the length of the cranks are varied to accommodate the torso of the rider. Another advantage of this invention is the forks can be manufactured with any suitable lightweight and strong material that is known. Another object of this invention is to provide adjustable handle bars that can be locked in multiple comfortable positions. A locking pin is easily clamped to the fork tube and the pin is spring released to align with the sprocket teeth openings. The front forks are made from steel or aluminum or any other light weight and strong material. The bottom end of the tubes has dropouts welded on or formed on. The drop outs are openings for the wheel axle to be attached either with bolts or a quick release bolt. More and more you see riders with extended stem risers on beach cruisers. The average person just wants to go from A to B and be comfortable. Yet another object of this invention is to be the first to use graphene for the front forks as it is 100 times stronger than steel. It is an object of this invention to keep the front wheel drive as light and strong as possible without sacrificing strength and safety. Many further objects and advantages will become evident as we continue to build and test prototypes before mass production. The advantage of this invention is that it functions well and looks cool at the same time. Dual crown front forks are a big advantage. They safely support the handle bar assembly in an open source environment and allow the chain or belt drives to be easily made taught because the attached stems are slide ably adjustable. Dual crown front forks look good and safely attach the wider front hub and add more strength and support to the rotating chain or belt driven handle bar assembly. Attaching lights, a locking pin or a wind/chain cover are all easily attached to the extended dual crown front forks. The fork tubes are perfect for attaching any and all modern day add accessories, such as speakers and smart phone accessories. It is not the intent to limit the scope of the invention to the above described embodiments.

### BRIEF DESCRIPTION FO THE DRAWINGS

FIG. 1 is perspective side view of a dual drive bicycle incorporating the front wheel drive train of the invention in the form of a conversion kit mounted on a conventional single speed bicycle with a coaster brake.

FIG. 2 is a perspective frontal view of the dual drive bicycle illustrated in FIG. 1.

FIG. 3 is an enlarged frontal view of a front wheel drive conversion kit of the invention mounted on a bicycle, showing a multi-geared front hub, hand brakes, cable and derailleur.

FIG. 4 is a side view of the triple pair sprocket and chain assembly used in the preferred embodiment of the invention.

FIG. 5 is a detailed view of the plastic chain cover and the individual links used in the front wheel drive train of the invention.

FIG. 6 is a side view of a common belt drive and pulley used in an alternate embodiment.

### DETAILED DESCRIPTION OF THE PREFERRED EMBODIMENT

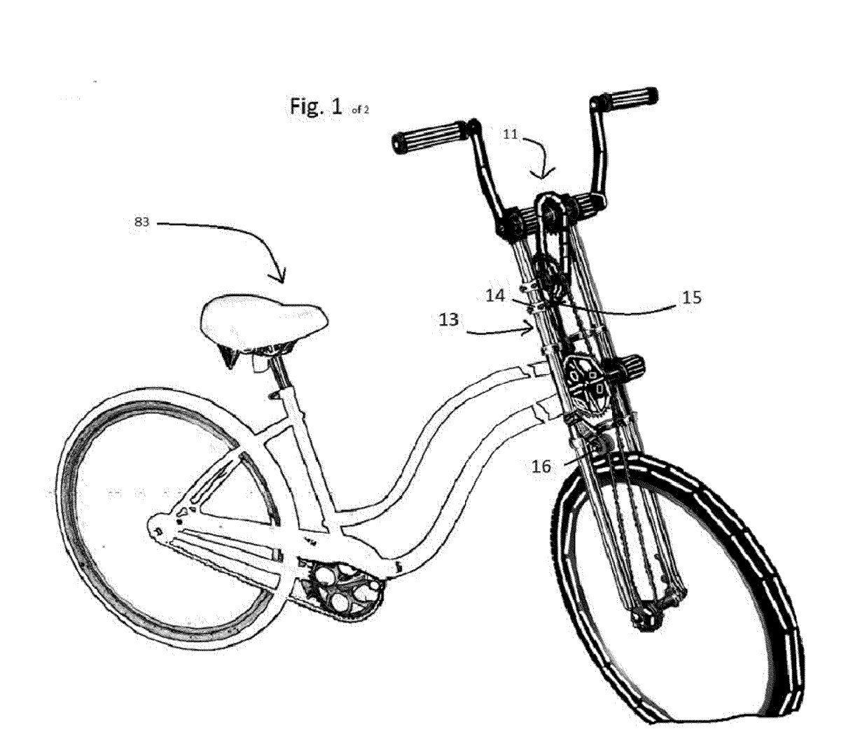

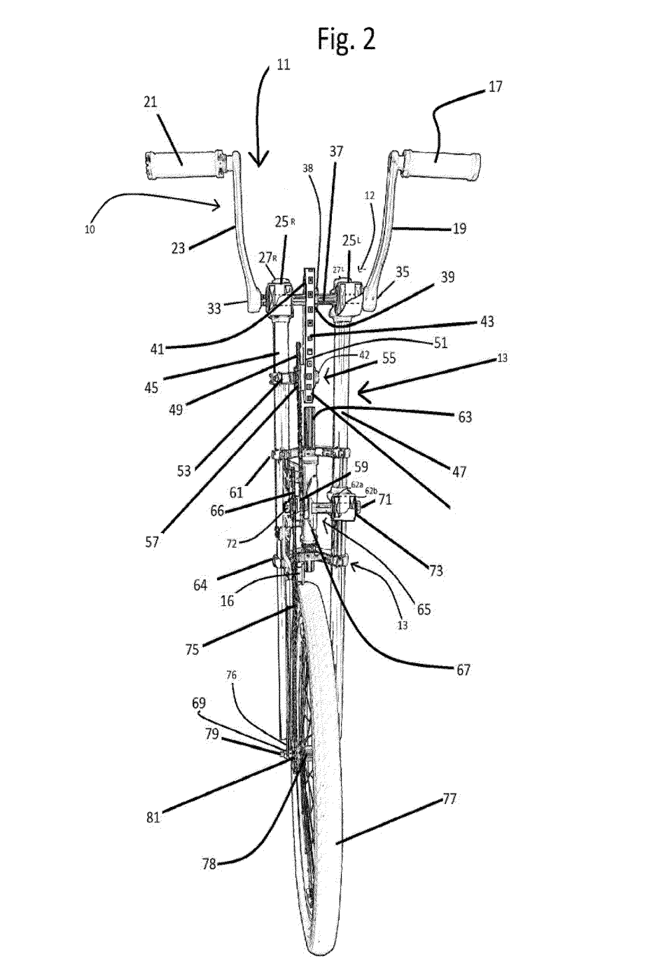

Numbers 11-100 designate structural components in FIGS. 1-6.
10. Handle bar axle assembly—Includes LR handles, LR cranks, LR Double Clamp Assemblies, axle, LR axle bolts, axle collar and driver sprocket
11. Front Wheel Drive Conversion Kit Assembly (includes 10-100)
12. Stem Assembly (includes two clamping members, the first clamps onto the fork tube and the second more forward section clamps an inner metal housing that houses two axle bearings (partially shown FIG. 2)
13. Dual Crown Front Fork Assembly (includes two front fork tubes {L,R} with drop outs for attaching the front wheel, a central tube, 2 triple TEE clamps also known as crowns, {45, 47, 61, 63, 64}
14. Clamp for locking Pin
15. Spring loaded locking pin
16. Idler wheel chain tensioner
17. Left handle
19. Left crank
21. Right Handle
23. Right crank
25. Housing member R, L (of Stem Assembly 12)
27. Fork clamp member R, L (of Stem Assembly 12)
33. Right axle bolt
35. Left axle bolt
37. Axle
38. Axle Collar
39. Driver sprocket (20 teeth)
41. First chain
42. Clamp bolt
43. Chain cover
45. Right fork tube
47. Left fork tube
49. Second Chain
51. Second sprocket (13 teeth)
53. Slide able clamp
55. Gear Assembly (includes 2 chain sprockets {2 and 3}, bolt used as an axle, two bearings, sprocket housing)
57. Third sprocket (28 teeth)
59. Fourth sprocket (13 teeth)
61. First triple tee clamp (located top of head tube)
62. Bearings a, b
63. Central stem tube (fits into head tube)
64. Second Triple tee clamp (located bottom of head tube)
65. Second Sprocket Assembly (includes 2 chain sprockets {4 and 5}, axle bolt, two bearings, and sprocket housing)
66. Fifth sprocket (32 teeth)
67. Bicycle head tube
69. Nut
71. Bolt
73. Stem mount
75. Third chain
76. Drop outs
77. Front wheel
78. Front freewheeling hub
79. Front wheel axle nut
80. Disc brake mounts
81. Driven front wheel sprocket (sprocket 6, 16 teeth
82. Multi geared front hub
83. Dual Drive Bicycle Assembly (includes a conventional rear drive bicycle with a front wheel drive conversion kit assembly {11}) MD mounted into the head tube of the bicycle
85. Derailleur
87. Hand brakes
89. Brake cable
92. belt dive assembly
93. Wider spaced front fork
95. Shifter
97. Shifter cable
100. Triple chain drive assembly

The invention is a dual drive bicycle that utilizes a dual crown front fork as a support frame for a front hand pedaled, independent, chain driven rotary transmission. Traditional foot pedals power the rear wheel. The front wheel drive fits into the head tube of any bicycle and replaces the front wheel, the forks and the handle bars with a front wheel drive transmission that is powered by the hands. Further details are provided below.

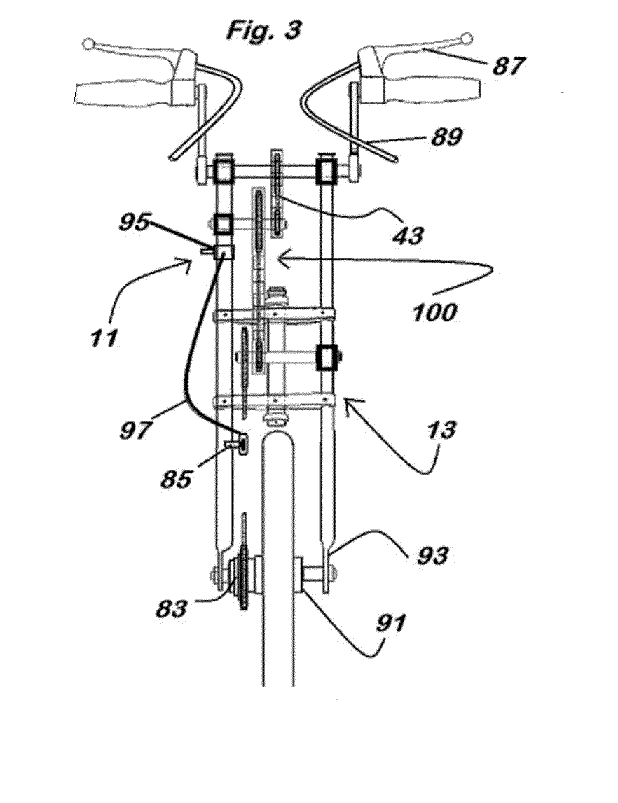

FIG. 1 shows a dual drive bicycle assembly 83 which includes a conventional foot pedaled and single speed rear drive with coaster brakes. A front wheel drive conversion kit assembly 11 transforms the traditional foot pedaled bicycle into a hand and foot powered bicycle with two independent drives. In this embodiment, conversion kit assembly 11 utilizes a chain drive. Another embodiment not shown uses a belt drive and hand pedals to power the front wheel. Also, other embodiments use multi geared rear drives in combination with hand lever actuated brakes. Phillips discloses hand-lever actuated brakes that rotate in his 1988 U.S. Pat. No. 4,773,662. These can easily be added and they function fine with my invention as well. But, it is not a preferred embodiment as sometimes less is more. The recent trend in the industry is toward fixie bikes with no brakes and fixed gears. The conversion kit includes parts 11-83 discussed in further detail and shown in FIG. 2. A stem assembly 12 is mounted at the top of the left and right fork and is shown more clearly in an enlargement in FIG. 3. Another stem assembly 12 is clamped further down and around the left fork tube and located opposite the head tube. The stem assembly is traditionally used in the bicycle industry to clamp the stem and the handlebars. I have adapted the stem assembly to clamp the fork tubes and a bearing sleeve. The top two stem assemblies consist of two different sized clamps welded together. The 1.25″ member clamps onto the fork tube and the more forward 1.5″ sized section clamps an inner bearing sleeve that houses two bearings. (See FIG. 2 partially exposed view of bearings). These are common bicycle stems. Some are made longer and are adjustable for height. The adjustable stems are used in another embodiment for taller riders. Other embodiments use different sized clamps to fit different sized forks and different sized bearing sleeves. It is not my intent to limit the scope of this invention to a particular size front fork tube or stem type.

Different materials are used for the fork tubes such as aluminum, steel, chromium, graphite and titanium to name a few. Graphene is an exciting new material that is used for yet another embodiment of this front wheel drive invention. Any light weight material that is known in the industry is used for different embodiments. The use of different materials varies the ODs and IDs of the forks and clamps and the clamping sizes vary accordingly. A clamp 14 for a spring loaded locking pin 15 is attached to the fork tube. Clamp 14 is slide adjustable so the attached locking pin can be positioned to align with the sprocket teeth. Clamp 14 is then tightened around the fork tube and locked in position. When the locking pin is extended, it stops the sprocket from rotating and effectively locks the handle bars in place. When the spring loaded pin is drawn back the handles are free to rotate and power the front wheel. The handles can be locked in multiple comfortable positions. Phillips discloses this type of spring loaded locking pin and it is well known in the industry. My invention, locates the pin with a slide adjustable clamp which clamps the fork tube. A dual crown front fork assembly 13 is used as a support frame for the entire independent front wheel drive. Front fork assembly 13 includes two fork tubes, a central tube and at least two triple tee clamps. A chain tensioner idler wheel 16 is used to tension the chain going down to the front wheel. Tensioner 16 is attached to a slide able fork tube clamp. Another embodiment replaces the tensioner and uses a derailleur system to change a cassette of gears at the hub.

FIG. 2 shows a conversion kit 11 which fits a head tube 67 of any velocipede. There are three common sizes of head tubes in the bicycle industry and they are 1″, 1⅛″ and 1¼″. A right Handle 21 is connected to a right crank 23. A left handle 17 is connected to a left crank 19. Both cranks are operatively connected to an axle 37. A left axle bolt 35 and a right axle bolt 33 fixedly attaches cranks 19 and 23 to the axle. The Stem Assembly is clamped to the top of each fork. A right and left forward housing 25 L, R house two axle bearings that support and position axle 37. Housing member 25R is welded or forged to a right fork clamp member 27R of Stem Assembly 12. Left housing member 25 L is welded or forged to a left fork clamp member 27 L of Assembly 12. Right fork clamp 27R clamps around and is affixed to a right fork tube 45. Left fork clamp 27 L clamps around and is affixed to a left fork tube 47. An axle collar 38 is positioned with set screws and a keyway on axle 37. Clamp collar 38 has threads to receive a driver sprocket 39. The clamp collar and attached driver sprocket 39 are operatively connected to the axle in a fixed middle position on the axle with set screws and keyway pin not shown. Rotation of the handles results in rotation of the connected axle and driver sprocket. For this embodiment, driver sprocket 39 has female threads and has nineteen teeth. Other embodiments have larger or smaller numbers of teeth for the driver sprocket and are attached to the axle by known means by those skilled in the art. A first chain 41 is short in length and is operatively connected to a second sprocket 51. Sprocket 51 has 14 teeth. A 1:1.35 gear speed ratio is achieved by connecting the driver sprocket to the second sprocket via a chain 41. A chain cover 43 has plastic links that cover chain 41. The plastic links are spaced the same as the chain and move with the chain. Chain cover 43 comes in various colors and adds an industrial look to the dual drive bicycle. The chain cover is lightweight and solves the age old problem of getting grease on the clothing. The chain cover is normally used to hold cable in the robotics industry. A first sprocket assembly 55 is attached to right fork tube 45 by a slide able clamp 53. Clamp 53 has female threads. Chain tensioning is easily achieved by sliding sprocket assembly 55 to proper chain tension position, up or down the fork tube. The first sprocket assembly includes two bearings, a bolt, and a housing. The housing has outer surface ridges in the shape of a Shimano free hub that aligns and holds in place two sprockets, sprocket 51 and a third sprocket 57. Third sprocket 57 has 28 teeth. A bolt 42 has male threads at one end and is thread ably attached directly to clamp 53 female threads. The bolt slides through the two inner bearings not shown and affixes the sprocket assembly to clamp 53. A second chain 49 operatively connects sprocket 57 to a fourth sprocket 59.

Sprocket 59 has 14 teeth. Connecting these two sprockets of 28 and 14 teeth achieves a gear speed ratio of 1:2. The total ratio is now 2 times 1.35 for a net gear speed ratio of 1:2.70. Other embodiments vary the number of sprocket teeth and easily achieve different gear speed ratios in this open source gear arrangement. Changing gear speed ratios by varying the size of the gears is easy. A simple chain breaker is used to add or subtract chain links. One of goals of this invention is to appeal to the tinkerer mentality of most cyclists and provide an easy way to change the gear speed ratio to custom fit to the individual rider preferences. Seeing three chains and 6 sprockets in motion just might induce light bulbs to go off in young minds. This invention would make a great teaching tool for engineering 101. Further down the left fork tube a second sprocket assembly 65 is clamped in position with a third stem mount 73. Sprocket assembly 65 has a bolt 71 that is used as an axle, and two axle bearings, (partially shown), a Shimano type free hub housing and sprocket 59 and a fifth sprocket 66 that slide onto the Shimano free hub. Sprocket 66 has thirty two teeth. Bolt 71 first slides through a bearing 62 a b. Bolt 71 is longer than bolt 42 and continues through two additional bearings in assembly 65. The bolt is fastened at the end by nut 69. A long spacer, not shown, is slid over the bolt and separates the inside bearings between the assembly and the double clamp bearings. The second sprocket assembly also has outside ridges that align with Shimano type sprockets. A third chain 75 connects sprocket 66 to a driven front wheel sprocket 81. Sprocket 81 is the sixth sprocket. It has 16 teeth and is attached to a front freewheeling hub 78. Connecting chain 75 to sprocket 66 and 81 enables a third gear speed ratio of 21:2. The total net gear speed ratio from the driver gear at the top to the hub connected driven gear is 2×2.7 or 1:5.4. This net gear speed ratio provides a nice steady, smooth and controlled rotation for the handles during operation. When the handles are rotated forward the entire assembly of connected chains is set in motion and drives the front wheel forward. If the handles are rotated backwards the front wheel freewheels. During operation of the dual drive bike the front wheel coasts when the handles are held stationary. Using coextensive handle position is the preferred embodiment for a safe easy ride.

A front wheel 77 is connected to a right drop out 76. (The left drop out is not shown). The dropouts are attached and normally welded to the bottom of the fork tubes. A left nut 69 along with a right nut (not shown) attaches the front wheel to the dropouts. Front wheel 77 replaces the standard front wheel with a wider hub rear wheel. Prior art, such as Phillips does not replace the front forks but rather spreads them wider to fit the wider rear hubs for his conversion kit. This puts undue stress on the forks. Replacement of the forks is necessary for safety reasons alone when using wider hubs. Total replacement of the traditional front forks with wider spaced drop outs is an advantage over the prior art. It allows the fork dropouts to accommodate the wider rear hubs. A preferred embodiment is an internal shifting front hub. Internal shifting hubs and most multi sprocket rear hubs use a wider 135 mm OLD distance. Front wheels usually use 110 mm OLD distance. Chain tensioner 16 is used for tensioning the third and longest chain. In another embodiment the front wheel has a multi-geared internal shifting front hub and a derailleur replaces tensioner 16. Fastening the fork tube drop outs to the front wheel axle is either accomplished by tightening the nuts or a quick release set up is used that is common in the bicycle industry. A first triple tee clamp 61 clamps both left and right fork tubes and a central stem tube 63 directly above the head tube. A thread less headset is commonly used as steering tube bearings. Another embodiment use a threaded headset. Any known steering stem bearing set ups can be used with the dual crown forks. Central tube 63 is slid up into the head tube of the bicycle. The central tube is used to attach the front wheel drive conversion kit assembly to the bicycle. The central tube and two front fork tubes are clamped in position in close proximity to the top of the head tube of the bicycle. The three tubes are clamped in close proximity to the bottom of the head tube by a second triple tee clamp 64. The use of two triple tee clamps, positioned above and below the head tube, very effectively attaches the independent front wheel drive system to any velocipede. It also adds strength where more strength is needed. The central tube is the steering mechanism for the handle assembly.

A third triple tee clamp or crown is used in another embodiment and located closer to the top of the forks for added strength. The central tube is manufactured longer to reach the third crown for this embodiment. Utilizing a dual crown front fork assembly as the support frame for the front wheel drive system allows all chains and sprockets to be located inside the protective forks. Using three chains instead of two chains keeps the sprockets smaller in size. Previous chain driven front wheel drives used huge fifty two tooth sprockets at the top that were dangerously close to your face and hair. Trying to cover the chains proved to be unsightly, cumbersome and added weight. The dual crown forks used as a support frame allow the chains to be easily tensioned by sliding and tightening the clamps. The tensioner is easily added and adjusted as well. It is also a simple matter to attach the support frame and total front wheel drive assembly to the head tube via the central tube of the triple tee fork set up. In yet another embodiment a head tube shim is added to fit the tube diameter to any sized head tube ID. In an0ther embodiment a clear plastic wind screen chain guard is also easily attached to the fork tubes via slide able clamps. In another embodiment a basket is added as an accessory and also functions as a chain guard. LED lights are easily added by clamping them to the fork tubes in yet another embodiment. The dual crown forks used as a support frame for a chain or belt driven front wheel drive system solves many of the problems of the prior art. Accessories are easily added with tube fork clamps. Adding the structure of a third chain and sprocket combination decreases the overall size of all the sprockets and makes it a safer bicycle to ride. As compared to the prior art, the smaller driver sprocket is less likely to cause an injury. The moving plastic chain cover guards against grease and loose clothing getting caught in the top chain. It is also lighter. Easy access to the chains and sprockets makes maintenance a snap. One of the goals for this preferred embodiment is to keep the top sprocket as small and unobtrusive as possible. This is accomplished by utilizing 3 gear trains with three 3 chains and smaller sprockets to achieve the desired 5-6 to 1 gear speed ratio. Another preferred embodiment uses a very small nine tooth BMX sprocket at the front hub.

This particular type of sprocket is made with pawls and inserts directly into the hub like a standard free hub cassette body. The standard 16 tooth thread on freewheel sprocket is replaced by a BMX 9 tooth sprocket with pawls. Two instead of three chains are used for this embodiment. The top driver sprocket has nineteen teeth and is connected to an eleven tooth sprocket via the first chain. The third sprocket has twenty eight teeth and is connected to the BMX nine tooth via the second chain. This combination nets a desirable overall gear speed ratio of 1 to 5.5. The sprockets are kept very small in the present invention in contrast to the prior art. The dual crown forks easily accommodate any combination of sprockets and gear speed ratios. Use of the dual crown fork as a support frame will make this dual drive bicycle product successful in the fitness marketplace and loved by the techie bicycle garage mechanics. Any accessory is an easy add on to the fork tubes with slide able clamps.

FIG. 3 shows the dual crown front fork assembly 13 and an enlarged view of one of the stems of assembly 12. The stems are common in the industry and manufactured to clamp different sized tubes. Some are made different lengths and made adjustable. The longer adjustable types are used as a preferred embodiment to fit taller riders. Use of longer stems for the handle bar assembly extend further outward and up higher to better fit the taller rider without having to use a larger bike frame size. Hand brakes 87 have cable 97 connected to brakes at the front and rear wheels (not shown). Derailleur 85 is operatively connected to shifter 95 which are used to select gears of multi geared front hub 82. The dual crown front forks of assembly 13 are more clearly shown. Stem assembly 12 is more clearly shown as an enlarged view. The stems are common in the bicycle industry. The use of two stems to hold bearings and a rotatable handlebar axle is a new use for bicycle stems. The advantage of the stems is that they are able to slide along the fork tubes which make chain tightness adjustment very easy. Any locking pins, shifters, or lights are easily added anywhere along the front fork tubes as well. Wider spaced front forks 93 is shown to demonstrate how the individual fork tubes are flip flopped so that the weld of the drop out is to the outside which allows the wider spacing for a 135 mm multi-geared hub. Triple chain drive assembly 100 demonstrates the use of 3 gear trains to accomplish the use of smaller in size gears that achieves the desired 5 to 6 to 1 gear speed ratio with a more pleasing final look. The chain cover 43 is used on gear trains 1 and 2. Chain three uses a derailleur and the chain cover won't work with a derailleur. All the chains are sandwiched between the front forks for added protection.

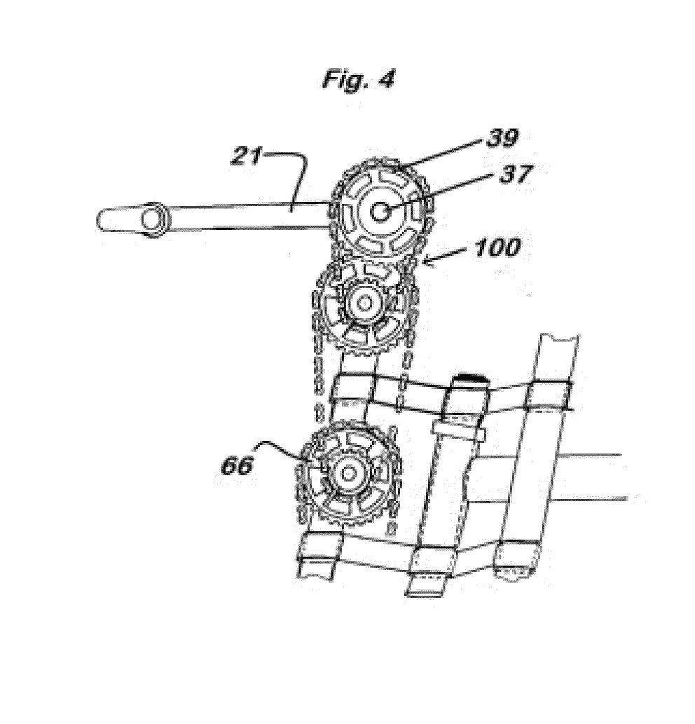

FIG. 4 is a side view of the triple chain drive assembly 100 showing the use of three separate chains and three separate gear trains in series to accomplish the desired 1:5-6 gear speed ratio with a smaller overall configuration of gears. It is an open source set up and the sprockets can easily be accessed and changed out for different sized sprockets to achieve the individual's preference for his or her workout.

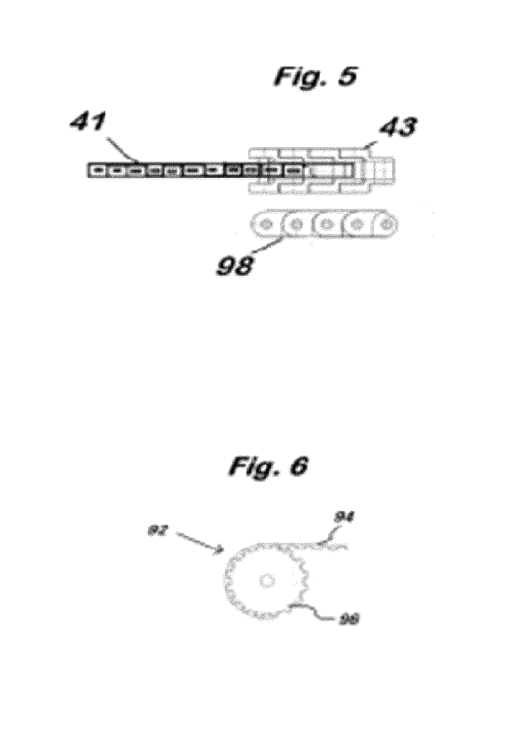

FIG. 5 discloses the individual links 98 of chain cover 43 and shows how chain 41 fits inside the cover. The cover can easily be removed by unsnapping one of the plastic links and pulling it off for lubrication or maintenance.

FIG. 6 discloses a common belt 94 and pulley 96 and belt drive assembly 92. The belt drive replaces the chain in yet another preferred embodiment. Belt drives are fairly common and well known in the bicycle industry. The belt drive more easily replaces chain drives 1 and 2 and would be a safer embodiment than chains.

In operation, a front wheel drive conversion kit assembly 11 is added to the head tube of a bicycle 67 and transforms it into a dual drive fitness bicycle. The handle bar assembly 10 is powered by the hands and forward rotation of handles 17 and 21 sets in motion the chains and gears and drives the front wheel 77 forward. Normally you would hop on the dual drive bike and pedal with your feet first to get the dual drive bicycle in motion. Your hands remain at rest until sufficient speed is attained for a balanced ride. It is then, if you choose to do so, you start pedaling with your hands as well as your feet at the same time. With enough forward momentum you can maintain a steady 10 miles an hour using just your arms. Your legs are much stronger at powering a bicycle. Pedaling with just your arms tires them out quickly, especially against the wind. If fatigue sets in, you just start pedaling with your legs again and give your arms a rest. It's great to have a choice and it's a fantastic total body workout. The handles are directly linked to the axle 37 by the LR crank arms 19 and 21. The forward rotation of the handles causes the connected top axle and first sprocket 39 to rotate. Three separate chains 41, 49 and 75 connect a total of 6 sprockets 39, 51, 57, 59, 66 and 81.

Forward rotation of the handles causes the connected chains and sprockets to drive the front wheel forward. The preferred gear speed ratio in the front is between is between 5 and 5.6 to one. For hill climbing it is preferable to have multiple gear changing choices. An internal shifting hub is a preferred embodiment for the front and even the back wheel. One can still use coaster brakes with some of the stock internal hubs. The independent front wheel drive adds power to climb a hill and increases the overall speed of the bicycle. Two stem assembly's 12 are used to attach the rotatable handles to the dual crown front fork assembly 13. Traditionally stem clamps have two clamping areas welded or forged together. They are used to attach a standard handle bar to the stem tube which is then inserted into the head tube. In this invention the stems attach to both fork tubes and the normal handle bar clamping portion is used to house a LR bearing sleeves with two bearings in each. The top handle bar axle is slid thru and the bearings facilitate smooth rotation. The use of four bearings to mount the axle adds strength to the handle bar system. The attachment of the handles to the dual drown front fork assembly 13 is simple and accessible for maintenance. Another preferred embodiment uses a more vertical stem tee type assembly that ratchets and locks in various angled positions.

During operation, the feet are pedaled as is normal for a traditional bicycle. Rotation of the handles imparts power to the front wheel and increases the overall speed of the bike. Rotation of the feet imparts power to the rear wheel. The drives are independent but both add speed and power to the overall ride. Total body fitness is the goal.

The handles are connected to a top axle. The axle passes thru left and right bearings. Bearing sleeves are slid through two stem assemblies that are attached to dual crown front forks. The dual crown front forks support the rotatable handle bar assembly. The top axle has a driver sprocket fixed to the center of the axle. The first driver sprocket is connected to a second driven sprocket drive via a chain or belt. A plastic chain cover with links is fit over the chains to protect the rider from grease. The chain cover rotates with the chain. The second gear train is connected to a third gear train via a third chain. The third chain drops down to the front wheel and connects to the front wheel. The front wheel like the rear wheel, has a sprocket attached. The front wheel free wheels just like the rear wheel so that you can coast without pedaling. The front wheel can have a multiple sprocket cassette set up with a derailleur and cable to switch gears. Attaching a free wheel cassette to the front hub allows the selection of various gear preferences. Belt drives are easily used to replace the chain drives. Belt drives are well known in the bicycle industry. Pedaling the rear with the feet or pedaling the front wheel with the hand powers the bike forward. Turning the dual drive bicycle is just as easy as a regular bicycle. You stop pedaling with your arms and make the turn. The arms are usually in the down position when making the turn and not rotating. Experienced dual drive cyclists are able to turn while continuing to rotate and power the bike with the arms. You can stand up with both legs straight and parallel while cruising with the handles held in the up position. Falling forward to rotate the arms while maintaining the straight leg position allows you to do shoulder shrugs all the way home. Riding the dual drive bike adds fun to any fitness biking routine. It surely deserves a place in the new cross fit community sweeping the country!

1. A dual-drive velocipede, comprising:
a frame having a rear wheel rotatably mounted therein, and a foot-pedal mechanism connected to the rear wheel via a rear wheel drive train that transfers energy from the feet of a rider to the rear wheel;
a steering assembly including a front fork having a front wheel rotatably mounted therein, a steering tube connected to the front fork, and a pivot joint pivotally connecting the steering tube to a front portion of the frame;
a front wheel drive train that transfers energy from the arms of a rider to the front wheel, including:
a stem assembly mounted on left and right forks of the front fork,
a horizontally-oriented crank shaft rotatably mounted in the stem assembly,
a pair of hand cranks connected on opposite ends of the crank shaft, and
at least two pairs of drive members and driven members that are serially-connected, the drive member of the first pair being connected to the crank shaft rotatably mounted in the stem assembly and the driven member of the first pair being connected to the drive member of the second pair.

2. The dual drive velocipede of claim 1 wherein the front fork is a dual crown, triple tree fork.

3. The dual drive velocipede of claim 1 wherein the front wheel drive train includes a third pair of drive members and driven members, wherein the driven member of the second pair is connected to the drive member of the third pair.

4. The dual drive velocipede of claim 1 wherein for each pair of the drive and driven members, one rotation of the drive member results in more than one rotation of its respective driven member.

5. The dual drive velocipede of claim 1 wherein the drive and driven members of each pair are a larger-diameter sprocket connected to a smaller-diameter sprocket via a drive chain such that one rotation of the drive member results in more than one rotation of its respective driven member.

6. The dual drive velocipede of claim 1 wherein a rotational speed ratio between the drive member of the first pair and the driven member of the last pair is 1 to 5 or larger.

7. The dual drive velocipede of claim 5 further comprising a chain tensioner.

8. The dual drive velocipede of claim 1 further comprising a multispeed front hub.

9. The dual drive velocipede of claim 1 further comprising a locking pin means.

10. The dual drive velocipede of claim 1 further comprising a derailleur and shifting means.

11. The dual drive velocipede of claim 1 wherein the front wheel drive train includes multiple drive chains.

12. The dual drive velocipede of claim 1 comprising finger actuated brakes.

13. A steering assembly pivotally mountable onto a frame of a velocipede, comprising:
a dual crown, triple tree front fork having a front wheel rotatably mounted therein, a steering tube connected to the front fork, and a pivot joint pivotally connecting the steering tube to a front portion of the frame;
a front wheel drive train that transfers energy from the arms of a rider to the front wheel, including:
a stem assembly mounted on left and right forks of the front fork,
a horizontally-oriented crank shaft rotatably mounted in the stem assembly,
a pair of hand cranks connected on opposite ends of the crank shaft,
a pair of rotatable handles connected to the hand cranks and
at least two pairs of drive members and driven members that are serially-connected by drive chains, the drive member of the first pair being connected to the crank shaft rotatably mounted in the stem assembly and the driven member of the first pair being connected to the drive member of the second pair, and wherein for each pair of the drive and driven members, one rotation of the drive member results in more than one rotation of its respective driven member.

14. The steering assembly of claim 13 wherein the front wheel drive train includes a third pair of drive members and driven members, wherein the driven member of the second pair is connected to the drive member of the third pair.

15. The steering assembly of claim 13 wherein the drive and driven members of each pair are a larger-diameter sprocket connected to a smaller-diameter sprocket via a drive chain such that one rotation of the drive member results in more than one rotation of its respective driven member.

16. The steering assembly of claim 13 wherein a rotational speed ratio between the drive member of the first pair of drive members and driven members and the driven member of the last pair is 1 to 5 or larger.

17. The steering assembly of claim 13 further comprising a plastic chain guard wherein the chain guard comprises oversized snap together links that fit over the drive chain of the first pair of drive and driven sprockets and rotate with the chain.

18. The steering assembly of claim 13 further comprising a chain tensioner.

19. The steering assembly of claim 13 further comprising a multispeed front hub.

20. The steering assembly of claim 13 further comprising a locking pin means to lock the hand cranks in multiple positions.

21. The steering assembly of claim 18 further comprising a derailleur and shifting means.

22. The steering assembly of claim 11 further comprising a belt drive rotary transmission system.

23. The steering assembly of claim 13 comprising finger actuated brakes.

24. The steering assembly of claim 13 wherein the front wheel drive train includes a combination of sprockets and pulleys, and at least one transmission belt.
